(19) United States
(12) Patent Application Publication
(10) Pub. No.: US 2011/0100943 A1
(43) Pub. Date: May 5, 2011

(54) Mast for a stacker crane

(76) Inventors: Christoph Hahn-Woernle, Stuttgart (DE); Nicole Riegler-Kurz, Murr (DE); Peter Lambeck, Stuttgart (DE)

(21) Appl. No.: 12/925,733

(22) Filed: Oct. 28, 2010

(30) Foreign Application Priority Data
Oct. 29, 2009 (DE) 10 2009 051 846.0

(51) Int. Cl. B66C 13/00

(52) U.S. Cl. 212/347

(57) ABSTRACT

The invention relates to a mast for a stacker crane.

In accordance with the invention, the mast has a supporting strut 12 and a reinforcing structure 14 connected to said supporting strut 12, the latter having at least one guide rail 16 for the stacker crane.

Use for example in high-bay warehouse.

The invention relates to a mast for a stacker crane.

Stacker cranes are used in high-bay warehouses and are movable in the vertical direction on a mast for accessing stored items positioned at different levels of the high-bay warehouse. The mast itself is movable inside a warehouse aisle. The problem with very tall masts or with high accelerations of the masts is that after acceleration or deceleration the masts continue to wobble, and it is necessary for this wobbling movement to fade before safe access into the high-bay warehouse. Besides this wobbling movement, the energy output required for operating the high-bay warehouse is also of importance. The lighter the mast can be built, the lower its mass to be accelerated and decelerated, and the lower the energy to be expended in doing so.

This application claims the priority of the German patent application No. 10 2009 051 846.0. The whole disclosure of this prior application is herewith incorporated by reference into this application.

The object of the invention is to provide an improved mast for a stacker crane.

In accordance with the invention, a mast for a stacker crane is provided to do so in which the mast has a supporting strut and a reinforcing structure connected to this supporting strut, the latter having at least one guide rail for the stacker crane.

In accordance with the invention, a division of the mast into a supporting strut and a reinforcing structure is provided. The supporting strut forms, thanks to provision of at least one guide rail, an extended-function tension/compression strut. Forces from the stacker crane are as a result only transmitted to the mast in the area of the supporting strut. The reinforcing structure by contrast serves only to strengthen the mast and can be adapted to match the boundary conditions to be met. The invention thus provides a mast of modular design which can for example be constructed in a building-block method adapted to the requirements. The supporting strut acts as a tension/compression strut and doubles as a roller track for rollers of the stacker crane. The design of the reinforcing structure is largely free and can be for example a lattice structure, made of laminated plastic or aluminium or the like. Depending on the boundary conditions to be met, for example the height of the mast, load capacities, access times and hence accelerations of the mast, an identical supporting strut can be combined with a variety of reinforcing structures in order to fulfil the respective boundary conditions in an optimum manner.

In a development of the invention, the supporting strut is designed as a plastic, laminated fiber or sandwich component.

In this way, it is possible to make high-strength yet lightweight supporting struts, in particular when fiber-reinforced plastic components are used.

In a development of the invention, the supporting strut is reinforced by fitted sections of pressure-resistant material in those areas forming the running tracks for rollers of the stacker crane.

In this way, it is for example possible to use a comparatively pressure-sensitive section as the supporting strut and to reinforce it using fitted sections only in the areas of the running tracks. For building the mast in accordance with the invention, it is thus possible for the first time to use pressure-sensitive materials, for example plastic sandwich components.

In a development of the invention, the sections are designed as bent sheet-metal parts or extruded metal sections. The sections are fastened to the supporting strut for example using clips, barbed hooks, screws and/or adhesive.

In this way, the supporting strut can be of simple design and optimally meet the strength requirements placed on the supporting strut in its function as a tension/compression strut and on the running tracks in respect of their compression strength and resistance to wear.

In a development of the invention, the supporting strut is designed as a plastic section formed in an extrusion, coiling or pultrusion process.

For example, fiber-reinforced plastic components can be used, in particular pultrusion sections. The supporting strut is advantageously designed as a plastic section consisting of a laminated fiber material.

In a development of the invention, the reinforcing structure has at least one plastic section formed in an extrusion, coiling or pultrusion process.

For example, the mast can comprise a supporting strut on the front designed as a pultrusion section and a reinforcing structure which also has a pultrusion section arranged on the rear of the mast. The two pultrusion sections, which do not necessarily have to be of identical design, can then for example be connected to one another by plates or by a lattice structure. The reinforcing structure advantageously has a plastic section comprising a laminated fiber material.

In a development of the invention, the reinforcing structure comprises several sections connected to one another and extending different distances when viewed in the longitudinal direction of the mast.

In this way, a tapering structure of the mast can be obtained in a particularly simple way. This does not require any tapering special sections, as used for example as masts for sailing boats; instead inexpensive standard sections with a constant cross-section are used to build the mast.

In a development of the invention, the reinforcing structure comprises several sections that are substantially identical.

Several identical sections then extend different distances in the longitudinal direction of the mast. In the lower area, for example, three sections glued to one another or connected in another suitable way are provided, while at the tip of the mast for example only one section is provided. The mast is thus particularly stable at its base in order to absorb the high forces occurring there. In the area of the mast tip, by contrast, the mast is particularly lightweight in design, so that a wobbling movement and also the overall weight of the mast are minimized.

In a development of the invention, the supporting strut comprises at least one first section extending over an entire movement range of the stacker crane with a guide rail arranged on said section.

In this way, the supporting strut can be manufactured particularly simply by providing a section with guide rails, for example strips with rectangular cross-section glued to a tubular section or connected to the section by means of screws.

In a development of the invention, the supporting strut comprises at least two sections arranged next to one another with substantially identical cross-section and extending over the entire movement range of the stacker crane.

In this way, a particularly stable supporting strut can be provided and it is also possible to design the supporting strut itself differently depending on the boundary conditions set. For example, several identical sections are connected to one another on the stacker crane for high maximum loads and each extend over the entire movement range of the stacker crane in order to provide a very sturdy supporting strut. With only low maximum loads on the stacker crane, it may be sufficient to provide only one of the sections on the supporting strut.

In a development of the invention, the supporting strut and the reinforcing structure are formed from sections with substantially identical cross-section.

In this way, one and the same section cross-section can be used for building the mast. In the area of the supporting strut, the section extending over the entire movement range of the stacker crane is provided with additional guide rails, while in the area of the reinforcing structure of the mast not necessarily all of the sections must extend over the entire mast length. It is of course also possible to use a section already provided with guide rails for the reinforcing structure too. The guide rails are then also present in the area of the reinforcing structure but are not used as such and contribute for example only to a further stiffening of the reinforcing structure.

In a development of the invention, the reinforcing structure is designed with a lattice structure.

A lattice structure permits high-strength yet lightweight reinforcing structures to be created. Since the supporting strut is, in accordance with the invention, used both as a tension/compression strut and as a roller track for rollers of the stacker crane, the design of the reinforcing structure is largely unrestricted. The lattice structure can be of varying design in order to build masts for different boundary conditions with identical supporting struts.

Further features and advantages of the invention can be found in the claims and the following description of preferred embodiments of the invention in conjunction with the drawings. Individual features of the various embodiments shown and described can be combined with one another as required without going beyond the scope of the invention. The drawings show in:

FIG. 1 a cross-section through a mast in accordance with the invention according to a first embodiment,

FIG. 2 a cross-section through a mast in accordance with the invention according to a second preferred embodiment,

FIG. 3 an enlarged view of the detail III from FIG. 2,

FIG. 4 a cross-section through a mast in accordance with the invention according to a third preferred embodiment,

FIG. 5 a side view of a mast in accordance with the invention according to a fourth preferred embodiment,

FIG. 6 a cross-section through the mast in FIG. 5 along the section plane VI-VI,

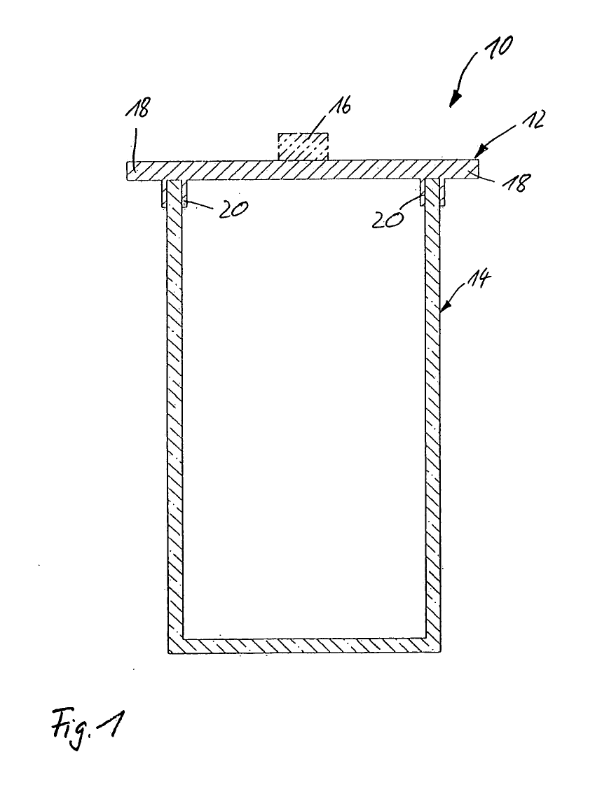

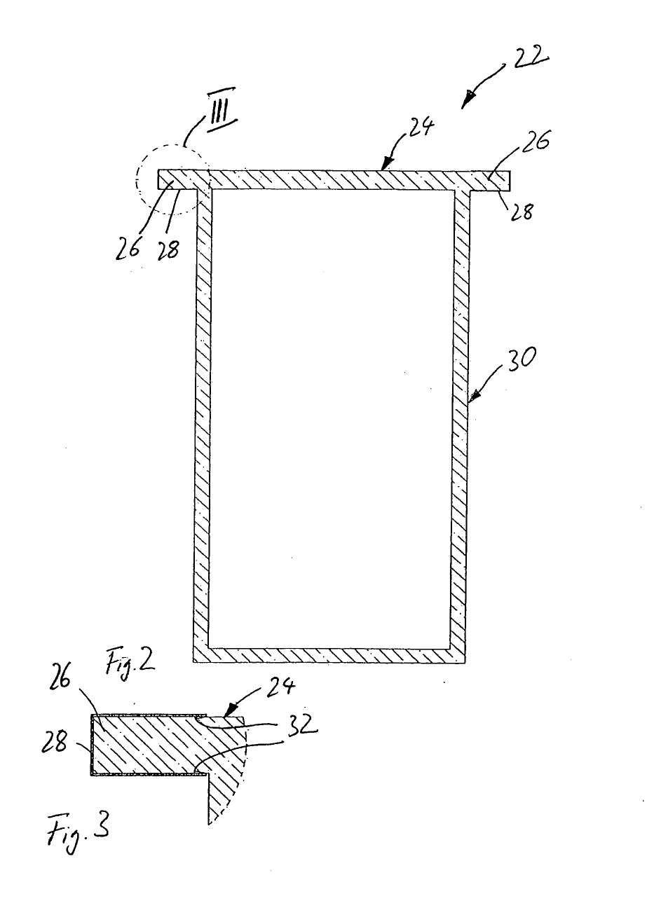

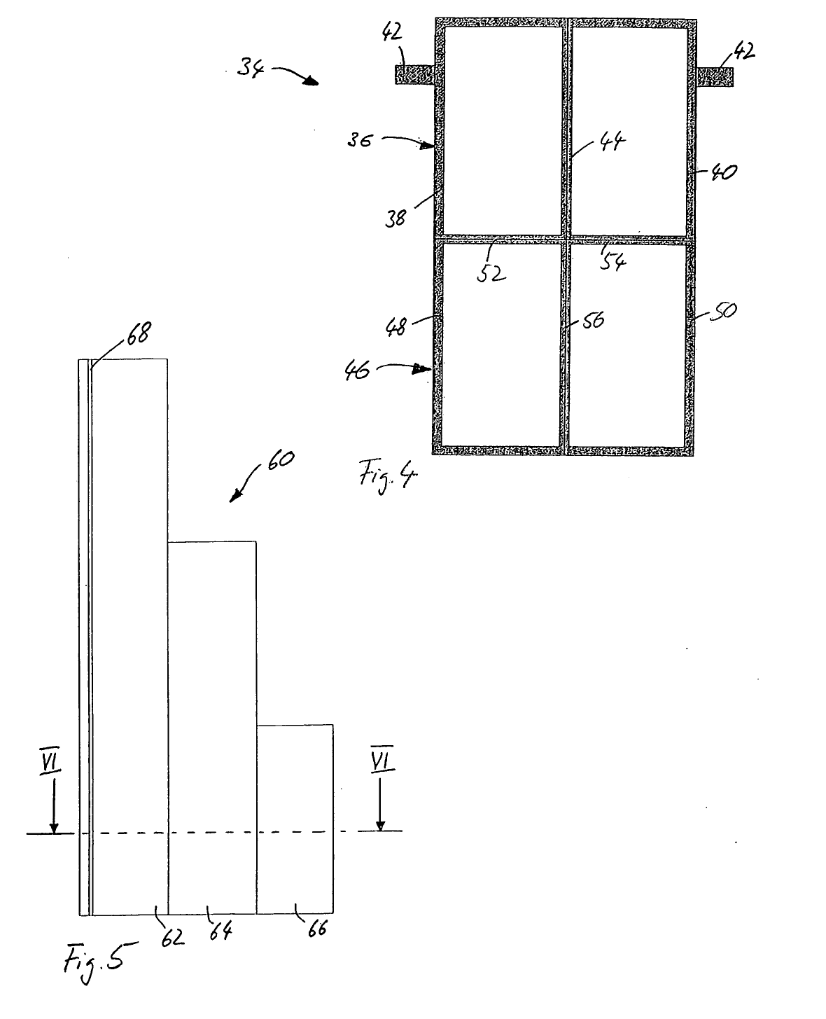

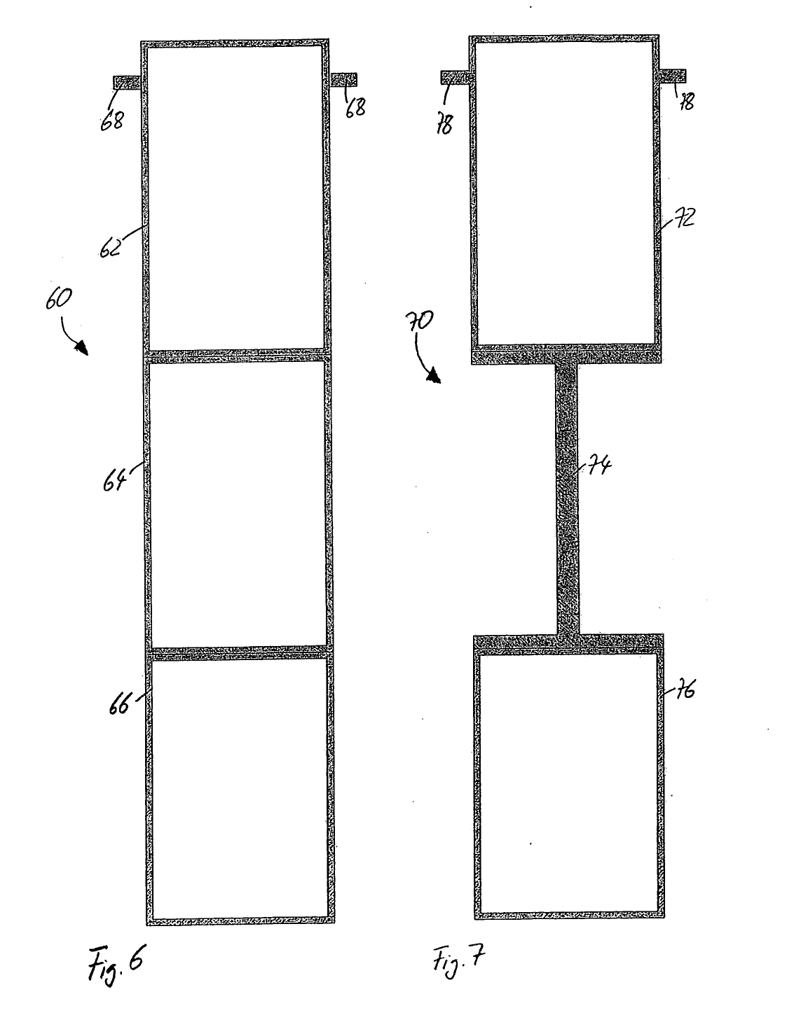

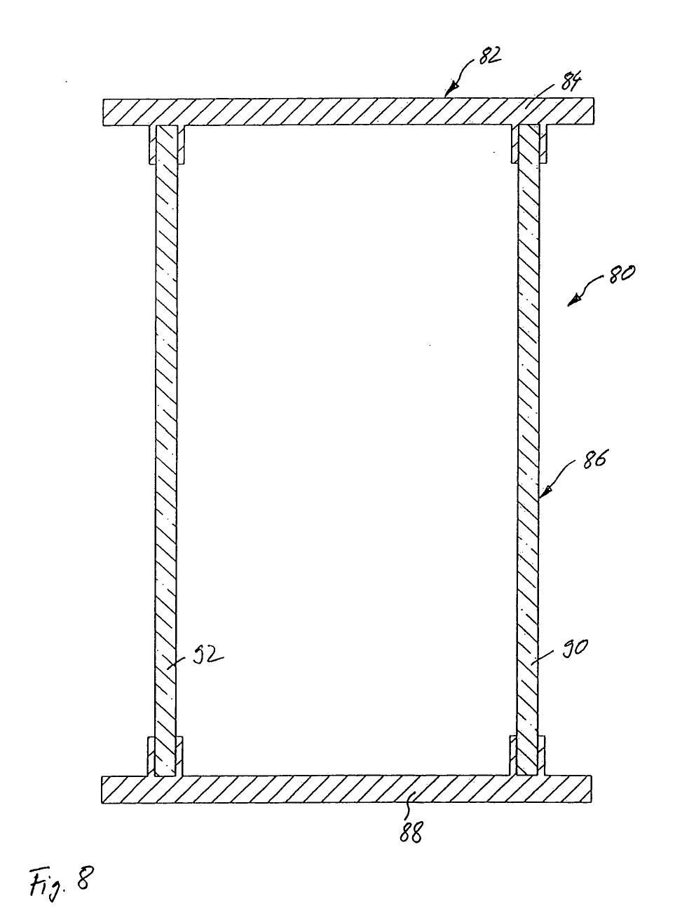

FIG. 7 a cross-section through a mast in accordance with the invention according to a fifth preferred embodiment,

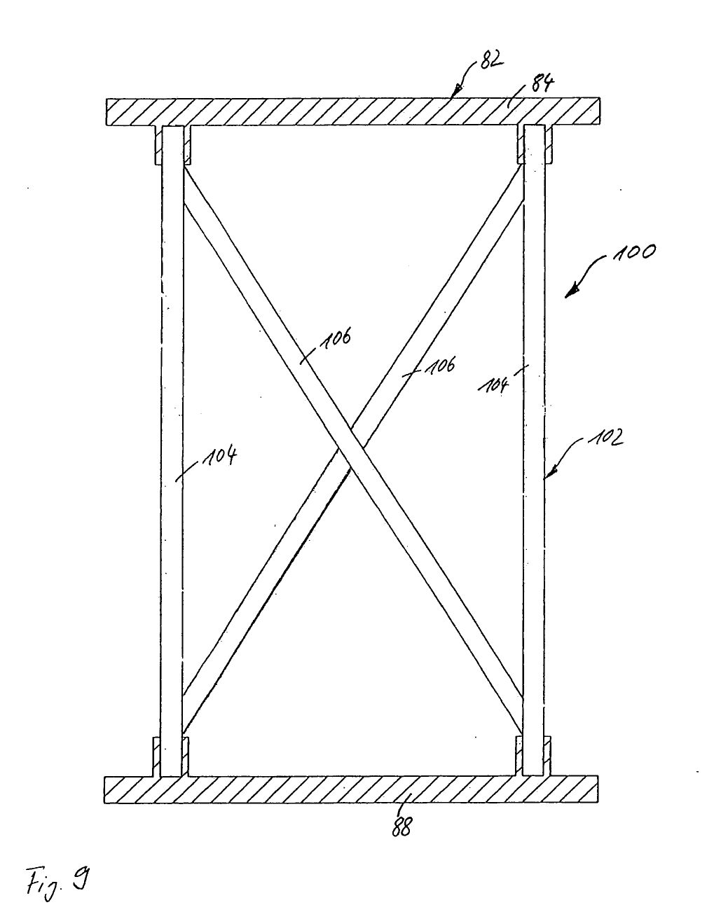

FIG. 8 a cross-section through a mast in accordance with the invention according to a sixth preferred embodiment,

FIG. 9 a cross-section through a mast in accordance with the invention according to a seventh preferred embodiment.

FIG. 1 shows a cross-section through a mast 10 in accordance with the invention. The mast 10 has a supporting strut 12 and a reinforcing structure 14. The supporting strut 12 is generally plate-like and provided on its front side facing away from the reinforcing structure 14 with a guide rail 16. A stacker crane, not shown, can be supported by suitable rollers on the guide rail 16 and additionally on the front and/or rear sides of the free ends 18 of the supporting strut 12.

On its rear side facing away from the guide rail 16, the supporting strut 12 is provided with insertion channels 20 extending over the entire length of the supporting strut 12. The channels 20 are set inwards relative to the free ends 18 of the supporting strut 12 so that a stacker crane can grip the supporting strut 12 at its free ends 18. The reinforcing structure 14 of U-shaped cross-section is inserted into the channels 20 and fastened in a suitable manner. The supporting strut 12 can for example be designed as an extruded aluminium section or also as a fiber-reinforced plastic pultrusion section. The reinforcing structure 14 can be designed as a sandwich component. A very stable yet lightweight mast is obtained in this way.

The division of the mast 10 in accordance with the invention into a supporting strut 12 and a reinforcing structure 14 allows the construction of the mast 10 to be adapted to the respective boundary conditions. The supporting strut 12 is for example used for different loads to be lifted and for different lengths of the mast. With heavy loads to be carried, however, the reinforcing structure 14 is designed stiffer and stronger. It is for example also possible to provide masts, with which high accelerations do not need to be used in operation, with a heavier but less expensive reinforcing structure 14. Conversely, the reinforcing structure 14 is designed very stiff and lightweight if high accelerations are anticipated.

The mast 10 in accordance with the invention is as a result of modular structure and the building of the mast 10 can be adapted to the different boundary conditions encountered in the manner of a building-block system.

FIG. 2 shows the cross-section of a further mast 22 in accordance with the invention. A supporting strut 24 is here provided with reinforcing sections 28 in the area of its free ends 26. The supporting strut 24 is designed plate-like and a stacker crane, not shown, is in rolling contact with the supporting strut 24 only in the area of the reinforcing sections 28. The reinforcing sections 28 on the free ends 26 form guide rails for a stacker crane. A reinforcing structure 30 is designed U-shaped and is connected to the rear of the supporting strut 24.

As can be seen in FIG. 3, the reinforcing sections 28 are designed U-shaped and are pushed onto the free ends 26 of the supporting strut 24. The reinforcing sections 28 are for example designed as bent sheet-metal parts.

Several wedge-shaped projections 32 projecting in the direction of the supporting strut 24 are provided in each case on the insides of the free ends of the two legs of the U-shaped reinforcing sections 28. These wedge-shaped projections 32 have the function of barbed hooks and ensure secure holding of the reinforcing sections 28 in the pushed-on state.

By providing the reinforcing sections 28, it is possible to use for the supporting strut 24 a material well suited for absorbing tensile and compression forces inside the cross-section of the supporting strut 24, for example a plastic sandwich material, but which is sensitive to compression forces onto its surface and on which surface the rollers of a stacker crane cannot be in direct rolling contact without causing damage to it in the long term. The rollers of the stacker crane now run exclusively on the reinforcing sections 28, which comprise very pressure-resistant material. This results in the option of designing the supporting strut 24 very light and nevertheless preventing damage due to continual operation of a stacker crane.

FIG. 4 shows a cross-section through a further embodiment of a mast 34 in accordance with the invention. The mast 34 has a supporting strut 36 having two sections 38, 40 of identical cross-section glued together. A guide rail 42 is glued to the sides arranged on the right and left in FIG. 4 of the sections 38, 40 respectively.

The sections 38, 40 have in the area of their side walls different wall thicknesses. For example, the outer side walls of the sections 38, 40 and the front surfaces are designed with double wall thickness, and the inner side surfaces and the rear surfaces are designed with single wall thickness. As can be seen in FIG. 4, the sections 38, 40 adjoin at their inner side surfaces and are glued to one another in this area so that an inner strut 44 with double wall thickness is obtained.

A reinforcing structure 46 also comprises two sections 48, 50 with identical cross-section, the cross-section of all sections 38, 40, 48, 50 being identical. The sections 38, 40, 48, 50 are arranged such that the outside walls have the double wall thickness and the inside walls the single wall thickness. As shown in FIG. 4, the sections 38, 40, 48, 50 with the walls having only the single wall thickness always adjoin an adjacent section, so that in the interior of the mast a total of four reinforcing struts 44, 52, 54 and 56 are formed which each have the double wall thickness.

The sections 48, 50 in the reinforcing structure 46 do not extend over the entire length of the mast. In the lower area of the mast, shown in section in FIG. 4, the four sections 38, 40, 48, 50 are thus available to absorb forces. In an upper area of the mast 34, only the sections 36, 40 are then still present. Since the forces occurring in the upper area of the mast 34 are less than in the lower area of the mast 34, material and weight can be saved when constructing the mast 34.

FIG. 5 shows a cross-section through a further embodiment of a mast 60. The mast 60 comprises in its lower area three tube-like sections 62, 64 and 66 arranged one behind the other and extending different distances in the longitudinal direction of the mast 60. The section 66 extends only about a third of the total length of the mast 60, the middle section 64 up to about two thirds of the length of the mast 60, and the section 62 over the entire length of the mast 60. The section 62 is provided on the sides with glued-on guide rails 68 with which rollers of a stacker crane can make rolling contact and which, like section 62, extend over the entire length of the mast and hence also over the entire movement range of a stacker crane on the mast 60. If the stacker crane is arranged at the top end of the mast 62, the highest forces occur at the base area of the mast. At the base area of the mast, the latter comprises three adjacently arranged sections 62, 64, 66 and can hence absorb the forces occurring. In the top area and in the middle area of the mast, lower forces occur, so that there the section 62 and the section 64 respectively are sufficient for safe absorption of the forces occurring. Compared with a mast with a constant cross-section over its full length, the mast 60 in accordance with the invention can thus be constructed more economically in material and light in weight.

FIG. 6 shows a view onto the section plane VI-VI in FIG. 5. It can be discerned that the sections 62, 64, 66 have an identical rectangular-tube-like cross-section with a wall thickness constant on all sides. The section 62 is provided on its outer side walls with the guide rails 68. The sections 62, 64, 66 comprise a plastic material, for example fiber-reinforced pultrusion or composite sections, and are glued to one another at their contact surfaces.

A further embodiment of a mast 70 in accordance with the invention is shown in cross-section in FIG. 7. The mast 70 comprises three sections 72, 74, 76 each with differing cross-section. The section 72 has a rectangular-tube-like cross-section and is additionally provided with guide rails 78 connected in one piece. The section 74 has an I-shaped cross-section. The section 76 has a rectangular-tube-like cross-section with smooth outer walls. The sections 72, 74, 76 are glued to one another on their respective contact surfaces and designed for example as fiber-reinforced pultrusion or composite sections.

A further embodiment of a mast 80 in accordance with the invention is shown in cross-section in FIG. 8. The mast 80 has a supporting strut 82 comprising a plastic pultrusion section 84. A reinforcing structure 86 also has opposite to the supporting strut 82 a plastic pultrusion section 88 of identical design to the section 84. The two sections 84, 88 are connected to one another by plates 90, 92 which can be designed as sandwich components. In the embodiment shown, the sections 84 and 88 are of identical design. This is not essential, but on the rear face of the mast facing away from the supporting strut 82 it is also possible to insert a pultrusion section differing from the section 84.

A further embodiment of a mast 100 in accordance with the invention is shown in cross-section in FIG. 9. The mast 100 has a supporting strut 82 designed identical to the mast 80 of FIG. 8. A reinforcing structure 102 of the mast 100 is however of different design from the mast 80.

The reinforcing structure 102 has on the rear side of the mast 100 opposite the supporting strut 82 the section 88, which is designed identical to the section 84 of the supporting strut 82 and is manufactured as a plastic pultrusion section. The two sections 84, 88 are however in the case of the mast 100 connected to one another by a lattice structure which in the embodiment shown comprises several plastic tubes 104, 106 connected to one another in lattice form. The plastic tubes 104 connect the sections 84, 88 and are aligned vertical to the front sides of these sections 84, 88. The plastic tubes 106 are arranged diagonally in each case. By providing a lattice structure, very lightweight yet sturdy masts can be built. Depending on the load to be expected, the lattice structure can then be of different design.

Alternatively, the entire reinforcing structure 14, 86, 102 can be designed as a lattice structure. A mast could then for example comprise the section 84, see FIG. 9, and a lattice structure attached to this section 84. The individual tubes of the lattice structure are advantageously made from fiber-reinforced plastics or aluminium.

1. Mast for a stacker crane, characterized in that the mast (10, 22; 34; 60; 70) has a supporting strut (12; 24; 36) and a reinforcing structure (14; 30; 46) connected to said supporting strut (12; 24; 36), the latter having at least one guide rail (16; 42; 68; 78) for the stacker crane and that the supporting strut (12; 24) is design as a plastic, laminated fiber or sandwich component.

2. Mast for a stacker crane according to claim 1, characterized in that the supporting strut (24) is reinforced by fitted sections (28) of pressure-resistant material in those areas forming the running tracks for rollers of the stacker crane.

3. Mast according to claim 2, characterized in that the sections (28) are designed as bent sheet-metal parts or extruded metal sections.

4. Mast according to claim 2, characterized in that the sections (28) are fastened to the supporting strut using clips, barbed hooks, screws and/or adhesive.

5. Mast according to claim 1, characterized in that the supporting strut (36) has at least one fiber-reinforced plastic section (38, 40; 62; 72) formed in an extrusion, coiling or pultrusion process.

6. Mast according to claim 5, characterized in that the reinforcing structure has at least one fiber-reinforced plastic section formed in an extrusion, coiling or pultrusion process.

7. Mast according to claim 1, characterized in that the reinforcing structure (46) comprises several sections (48, 50; 64, 66) connected to one another and extending different distances in the longitudinal direction of the mast.

8. Mast according to claim 7, characterized in that the reinforcing structure comprises several sections (48, 50; 64, 66) that are substantially identical.

9. Mast according to claim 7, characterized in that the supporting strut (12; 36) comprises at least one first section (38, 40; 62; 72) extending over an entire movement range of the stacker crane with a guide rail (16; 42; 68; 78) arranged on said section (38, 40; 62; 72).

10. Mast according to claim 9, characterized in that the supporting strut comprises at least two sections (38, 40) arranged next to one another with substantially identical cross-section and extending over the entire movement range of the stacker crane.

11. Mast according to claim 9, characterized in that the supporting strut and the reinforcing structure are formed from sections (62, 64, 66) with substantially identical cross-section.

12. Mast according to claim 1, characterized in that the reinforcing structure is designed with a lattice structure.
